(19) United States
(12) Patent Application Publication
(10) Pub. No.: US 2003/0085371 A1
(43) Pub. Date: May 8, 2003

(54) Hydraulically translated valve

(76) Inventor: Patrick Mattes, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/129,432

(22) PCT Filed: Nov. 8, 2001
(86) PCT No.: PCT/DE01/03088

(51) Int. Cl. F16K 31/12

(52) U.S. Cl. 251/57; 239/102.2

(57) ABSTRACT

A valve for controlling fluids is proposed, including at least one actuator unit (4) for actuating a valve member (3) which is axially displaceable in a bore (10) of a valve body (7) and which has at least one valve closing member (12), disposed in a valve chamber (18) and cooperating with at least a first valve seat (14), as well as a first piston (9) and a second piston (11). Between the pistons (9, 11), a hydraulic chamber (13) functioning as a hydraulic booster is disposed, which to compensate for leakage losses has a filling device, which comprises a pressure compensation conduit (24) that essentially transmits the pressure prevailing in the valve chamber (18) to the hydraulic chamber (13), making for a quasi-force-balanced valve (Drawing).

### PRIOR ART

The invention is based on a valve for controlling fluids as generically defined in further detail in the preamble to claim 1.

Such valves for controlling fluids are known from the industry. They are used for instance in fuel injectors, especially common rail injectors, and also in pumps of motor vehicles in the most various versions.

One such valve is also known from European Patent Disclosure EP 0 477 400 A1. This valve is actuated by means of a piezoelectric actuator. The deflection of the actuator is transmitted to the valve closing member via a hydraulic chamber acting as a hydraulic booster and a tolerance compensating element. The hydraulic chamber is located between the face ends of two pistons of different diameters, of which one, namely the piston with the greater diameter, is connected to the piezoelectric actuator, while the other, namely the one with the smaller diameter, is connected to the valve closing member. The hydraulic chamber is embodied such that the piston connected to the valve closing member, compared to the piston with the greater diameter that is connected to the piezoelectric actuator, executes a stroke that is lengthened by the boosting ratio of the piston diameter when the piston with the greater diameter undergoes a certain change in position by means of the electric actuator. Moreover, by way of the working volume of the hydraulic chamber, tolerances from different coefficients of temperature expansion, for instance, of the materials used and settling effects that may occur can be compensated for without any change in the position of the valve closing member.

The hydraulic system, in particular the hydraulic coupler, has a so-called system pressure, which assures the function of such valves. This pressure can drop as a consequence of leakage. Adequate replenishment of hydraulic fluid is therefore required.

Filling the system pressure region, for instance in common rail injectors known in the industry, in which the system pressure is expediently generated in the valve itself and is also kept as constant as possible upon system starting, is achieved by delivering hydraulic fluid. The filling is often done via leakage gaps, which are formed by leakage or filling pins. As a rule, the system pressure is adjusted by means of a valve. The system pressure can be kept constant for instance even when there are a plurality of common rail valves.

Since in the known valves of the type defined at the outset the piezoelectric actuator must work counter to a high pressure prevailing in the valve chamber, the actuator unit must be designed as correspondingly large. The design of the hydraulic booster until now has been characterized by a ratio of the areas of the piston and the valve seat of approximately 10:1. As a result, the maximum possible hydraulic coupler pressure is limited to one-tenth of the pressure prevailing in the common high-pressure chamber (common rail). Adjusting and checking the hydraulic coupler pressure to be adjusted is complicated and cost-intensive, however.

### ADVANTAGES OF THE INVENTION

The proposed valve for controlling fluids having the characteristics of claim 1 has the advantage over the prior art of providing a quasi-force-balanced switching valve, whose hydraulic boosting can be achieved economically and which moreover has an integrated system pressure supply.

Moreover, there is a robust system pressure supply, which because the filling of the hydraulic chamber required in the event of leakage takes place in the secondary flow is insensitive even to particles that may be present in the fuel.

A further substantial advantage of the valve of the invention is that because of the pressure compensation, effected by means of the pressure compensation conduit, between the hydraulic chamber and the valve chamber, less force capacity of the actuator unit is needed than in the valves of the prior art. Thus it is also possible to use piezoelectric actuators of small size.

In a preferred embodiment of the valve of the invention, the pressure compensation conduit branches off from the valve chamber. It preferably discharges at the level of the second piston into the bore for guiding the valve member. This is an especially economical embodiment, because a pressure compensation conduit embodied in this way can readily be integrated with the valve body.

To lend the system a guide pressure-holding capacity, the pressure compensation conduit expediently discharges into the bore for guiding the valve member at a distance from the hydraulic chamber.

To enable adjusting the hydraulic coupler pressure to the pressure in the valve chamber, the diameter of the second piston is advantageously essentially equivalent to the diameter of the first valve seat. This prevents an unintentional opening of the valve. For opening the valve, however, only a slight pressure rise in the coupler volume is necessary.

Further advantages and advantageous features of the subject of the invention can be learned from the description, drawing and claims.

### DRAWING

One exemplary embodiment of the valve of the invention for controlling fluids is shown schematically in the drawing and will be explained in further detail in the ensuing description.

The sole drawing FIGURE shows a schematic, fragmentary view of one exemplary embodiment of the valve of the invention, in conjunction with a fuel injection valve for internal combustion engines, in longitudinal section.

### DESCRIPTION OF THE EXEMPLARY EMBODIMENT

In the drawing, a valve of the invention is shown, which is a component of a fuel injection valve 1 for internal combustion engines of motor vehicles. In the present case, the fuel injection valve 1 is a common rail injector for injecting preferably Diesel fuel. The fuel injection is controlled via the pressure prevailing in a valve control chamber 2. The valve control chamber 2 communicates with a high-pressure supply, not shown here.

The actuation of the fuel injection valve 1 is effected via a valve member 3, which is guided in a bore 10 of a valve body 7. The valve member 3 is in turn triggered via an actuator unit, embodied here as a piezoelectric actuator 4. The piezoelectric actuator 4 is located on the side of the valve member 3 remote from the valve control chamber and the combustion chamber and in the usual way comprises a plurality of layers. On the side toward the valve member 3, the piezoelectric actuator 4 has an actuator head 5, and on the side remote from the valve member 3 it has an actuator foot 6, which is braced on one wall of the valve body 7.

The actuator head 5 is adjoined, via a support plate 8, by a transmission piston 91, which in turn is connected to a first piston 9 of greater diameter, which is associated with the valve member 3.

The valve member 3, which is fitted axially movably into the longitudinal bore 10 of the valve body 7, has in addition to the first piston 9 a second piston 11, which actuates a ball-shaped valve closing member 12 and will therefore hereinafter also be called an actuating piston. The diameter A1 of the second piston 11 is less than the diameter AO of the first piston 9.

The pistons 9 and 11 are separated from one another by a hydraulic booster, which comprises a hydraulic chamber 13 and which transmits the deflection of the piezoelectric actuator 4 to the actuating piston and thus to the valve closing member 12, via the first piston 9 or so-called control piston.

The hydraulic chamber 13, in which a system pressure p_sys prevails, encloses a common compensation volume between the two pistons 9 and 11 defining it. The compensation volume of the hydraulic chamber 13 serves to compensate for tolerances resulting from temperature gradients in the component or from different coefficients of temperature expansion of the materials used and possible settling effects, without affecting the location of the valve closing member 12 to be actuated.

The piezoelectric actuator 4, transmission piston 91, control piston 9, hydraulic chamber 13, actuating piston 11 and valve closing member 12 are all located, one after the other, on a common axis.

Because of the different diameters of the pistons 9 and 11 and the boosting ratio thus specified of the hydraulic chamber 13, upon actuation of the piezoelectric actuator 4 the actuating piston 11 executes a stroke that is longer by the boosting ratio than the control piston 9.

The ball-like valve closing member 12, disposed on the end of the valve member 3 toward the valve control chamber 2, cooperates with valve seats 14 and 15 embodied on the valve body 7. The valve seats 14 and 15 are located in a valve chamber defined by the valve body 7, in which chamber the valve closing member 12 is also disposed, and from which chamber a leakage outlet conduit 19 branches off, from the side of the valve seat 14 oriented toward the piezoelectric actuator 4. On the side of the valve seat 14 remote from the piezoelectric actuator 4, the valve chamber 18 communicates, via the second valve seat 15 and an outflow throttle 20, with the valve control chamber 2, which communicates with the high-pressure supply 17 and in which a so-called rail pressure p_R prevails.

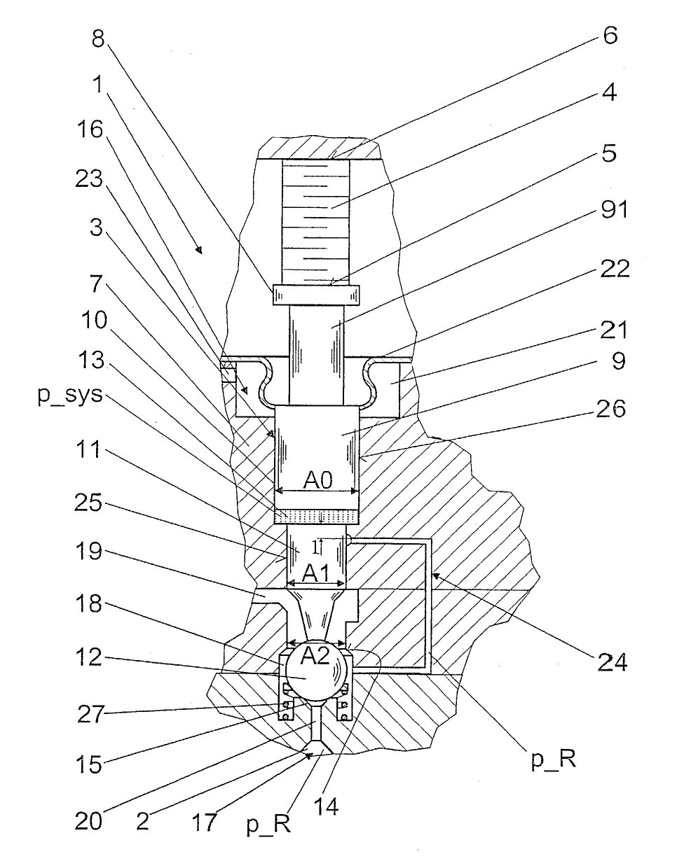

In FIG. 1, the valve control chamber 2 is merely suggested. An axially displaceable valve control piston, not identified by reference numeral, is disposed in the valve control chamber. By the axial motion of this piston, the injection behavior of the fuel injection valve 1 is controlled in a manner known per se. The valve control chamber 2 communicates in the usual way with an injection line, which communicates with a high-pressure reservoir, the so-called common rail, that is common to a plurality of fuel injection valves.

Located on the end of the bore 10 toward the piezoelectric actuator 4 is a further hollow chamber 21, which is defined by the valve body 7, the first piston 9, and a sealing element 22 that is connected to both first piston 9 and the valve body 7. The sealing element 22, which in the present case is embodied as a bellows-like diaphragm, assures that the piezoelectric actuator 4 will not come into contact with the fuel contained in the valve chamber 21. For carrying leakage fluid away, a leakage line 23 branches off from the valve chamber 21.

To compensate for leakage losses from the hydraulic chamber 13 upon an actuation of the fuel injection valve 1, the fuel injection valve has a filling device, which comprises a pressure compensation conduit 24. The pressure compensation conduit 24, which here has an essentially constant cross section, branches off from the valve chamber 18 on the side of the valve seat 14 remote from the piezoelectric actuator 4, passes through the valve body 1 and discharges at the level of the second piston 11 into the bore 10, in which the valve member 3 is guided. The mouth of the pressure compensation conduit 24 into the bore 10 is disposed at a spacing 1 from the hydraulic chamber 13. This spacing 1 from the actual coupler volume, that is, the hydraulic chamber 13, improves the pressure holding capacity when the valve closing member 12 is located at its second valve seat 14 and is therefore called the sealing length.

The filling of the hydraulic chamber 13 is then effected beginning at the mouth of the pressure compensation conduit 24 via an annular gap, which surrounds the actuating piston 11 and can have a width of approximately 1 to 1.3 μm. The actuating piston 11 itself has a diameter A1 of between 2 mm and 3 mm, for instance. The diameter A1 is equivalent to the diameter A2 of the valve seat 14. The diameter A0 of the first piston 9 is, as already noted above, greater than the diameter A1 of the actuating piston 11 and is selected for instance such that the ratio of the areas of the end faces, defining the hydraulic chamber 13, of the pistons 9 and 11 is between 1.1 and 1.3.

In each case, the indirect filling of the hydraulic chamber 13 serves to improve the pressure holding capacity in the hydraulic chamber 13 during the triggering. It is also conceivable for the pressure compensation conduit 24 to discharge into an annular gap 26 surrounding the piston 9, or directly into the hydraulic chamber 13.

The pressure compensation conduit 24 assures that essentially the same pressure prevails in both the valve chamber 18 and the hydraulic chamber 13. The system pressure p_sys is accordingly essentially equivalent to the rail pressure p_R. As a result, it is possible to actuate the valve closing member 12 with a lesser expenditure of force by means of the piezoelectric actuator 4. In other words, a quasi-force-balanced switching valve exists.

Because the diameter A1 is equivalent to the diameter A2, the coupler pressure, that is, the pressure 13 prevailing in the hydraulic chamber, can be equivalent to the pressure prevailing in the valve chamber 18, without the switching valve being opened unintentionally. For opening the switching valve, only a slight pressure rise in the hydraulic chamber 13 is needed. This pressure rise is generated by means of the piezoelectric actuator 4.

The combination of small piston diameters, in the range between 2 mm and 3 mm, and sealing gap heights (the width of the annular gaps 25 and 26 surrounding the pistons) of between 1 μm and 1.3 μm makes it possible to keep the leakage of the system so low that the entire common rail system is balanced in terms of quantity.

The ball-like valve closing member 12 is urged by a spring 27, for instance a spiral spring, in the direction of the piezoelectric actuator 4, such that the valve closing member 12 is located in the first valve seat 14 if no voltage is applied to the piezoelectric actuator 4, or in other words the piezoelectric actuator is not activated. In the present case, the spring 27 rests directly on the valve closing member 12. However, it could also engage the actuating piston 11 connected to the valve closing member 12.

The fuel injection valve shown in the sole figure of the drawing has a mode of operation that will now be described.

In the closed state of the fuel injection valve 1, that is, when no voltage is applied to the piezoelectric actuator 4, the valve closing member 12 rests on the valve seat 14 assigned to it, which in the drawing is the upper valve seat, and is pressed by the spring 27, among other factors, which spring is prestressed in a suitable way, and by the rail pressure p_R against the first valve seat 14.

In the event of a gradual actuation, for instance caused by temperature-dictated changes in length of the piezoelectric actuator 4 and other valve components, the first piston 9 functioning as a control piston plunges into the compensation volume of the hydraulic chamber 13 and is then retracted again from this chamber if the temperature drops, without any effect on the position of the valve closing member 12 and thus on the opening state of the fuel injection valve 1 overall.

For opening the valve, that is, if by means of the fuel injection valve 1 fuel is to be injected, for instance into an internal combustion engine, the piezoelectric actuator 4 is subjected to an electric voltage, causing it to undergo an abrupt, axially oriented change in length. The piezoelectric actuator 4 is braced via its foot 6 on the valve body 7 and, via the transmission piston 91 and the control piston 9, it builds up an opening pressure in the hydraulic chamber 13. By means of the hydraulic booster comprising the hydraulic chamber 13, the second piston 11 is thus moved, and hence the valve closing member 12 is forced out of its upper valve seat 14 into a middle position between the two valve seats 14 and 15. At the instant of activation of the piezoelectric actuator, essentially the same pressure as in the valve chamber 18 prevails in the hydraulic chamber 13; this is assured by means of the pressure compensation conduit 33. Any leakage that might occur via the annular gap 29 is compensated for by means of the pressure compensation conduit 33.

In order to move the valve closing member 12, after it has reached its second valve seat 15, which is the lower valve seat in the drawing, backward again into a middle position and thus achieve another fuel injection, the voltage applied to the piezoelectric actuator 4 is discontinued. By means of the spring 27, the valve closing member 12 is now urged in the direction of the valve seat 14. A pressure difference that prevails between the valve chamber 18 and the hydraulic chamber 13 when the valve closing member 12 is disposed in the valve seat 14 is then compensated for again by means of a re-forcing of fuel out of the pressure compensation conduit 33, extending in the valve body between the valve chamber 18 and the hydraulic chamber 13.

The exemplary embodiment described relates to a so-called double-seat valve. It is understood that the invention is also applicable to single-switching valves with only a single valve seat as well.

It is also understood that the invention can be used not only in the preferred application to common rail injectors as described here, but instead can be realized in general in fuel injection valves or in further hydraulically boosted systems with piezoelectric or magnetic actuators in other fields, such as in pumps.

1. A valve for controlling fluids, including at least one actuator unit (4), in particular a piezoelectric unit, for actuating a valve member (3) which is axially displaceable in a bore (10) of a valve body (7) and which has at least one valve closing member (12), disposed in a valve chamber (18) and cooperating with at least one first valve seat (14), and a first piston (9) and a second piston (11), between which pistons a hydraulic chamber (13) functioning as a hydraulic booster is disposed, which chamber, to compensate for leakage losses, has a filling device, characterized in that the filling device substantially comprises a pressure compensation conduit (24), by means of which a pressure prevailing in the valve chamber (18) can be transmitted to the hydraulic chamber (13).

2. The valve of claim 1, characterized in that the pressure compensation conduit (24) has an essentially constant cross section.

3. The valve of claim 1 or 2, characterized in that the pressure compensation conduit (24) branches off from the valve chamber (18).

4. The valve of one of claims 1-3, characterized in that the pressure compensation conduit (24) discharges at the level of the second piston (11) into the bore (10) for guiding the valve member (3).

5. The valve of claim 4, characterized in that the mouth of the pressure compensation conduit (24) into the bore (10) for guiding the valve member (3) is spaced apart from the hydraulic chamber (13).

6. The valve of one of claims 1-5, characterized in that the diameter (A1) of the second piston (11) is essentially equivalent to the diameter (A2) of the first valve seat (14).

7. The valve of one of claims 1-6, characterized in that the ratio of the areas of the end faces of the two pistons (9, 11), which faces define the hydraulic chamber (13), is between 1.1 and 1.3.

8. The valve of one of claims 1-7, characterized in that the second piston (11) has a diameter of at least approximately 2 mm to 3 mm.

9. The valve of one of claims 1-8, characterized in that the second piston (11) is surrounded by an annular gap (30) with a width of at least approximately between 1 μm and 1.3 μm.

10. The valve of one of claims 1-9, characterized by a spring (27), which urges the valve closing member (12) in the direction of the actuator unit (4) in such a way that the valve closing member (12), when the actuator unit (4) is unactuated, is located in its first valve seat (14).
